(19) United States
(12) Patent Application Publication
(10) Pub. No.: US 2020/0396988 A1
(43) Pub. Date: Dec. 24, 2020

(54) ANTIBACTERIAL FILM, ANTIBACTERIAL COMPOSITION, ANTIBACTERIAL FILM-ATTACHED SUBSTRATE, AND METHOD FOR IMPARTING ANTIBACTERIAL PROPERTY

(71) Applicant: FUJIFILM Corporation, Tokyo (JP)

(72) Inventors: Yoshihito HODOSAWA, Shizuoka (JP); Tomonari OGAWA, Shizuoka (JP); Takahiro HAYASHI, Shizuoka (JP)

(73) Assignee: FUJIFILM Corporation, Tokyo (JP)

(21) Appl. No.: 17/010,800

(22) Filed: Sep. 2, 2020

Related U.S. Application Data
(63) Continuation of application No. PCT/JP2019/007554, filed on Feb. 27, 2019.

(30) Foreign Application Priority Data
Mar. 9, 2018 (JP) 2018-043461

(51) Int. Cl. A01N 25/08; A01N 37/02; A01N 59/16

(52) U.S. Cl. CPC A01N 25/08; A01N 59/16; A01N 37/02

(57) ABSTRACT

A first object of the present invention is to provide an antibacterial film excellent in the antibacterial property and the antiviral property and resistant to discoloration. A second object of the present invention is to provide an antibacterial composition excellent in the antibacterial property and the antiviral property and capable of providing an antibacterial film that is resistant to discoloration. A third object of the present invention is to provide an antibacterial film-attached substrate provided with the above antibacterial film. A fourth object of the present invention is to provide a method for imparting an antibacterial property using the above antibacterial film and the above antibacterial composition.

An antibacterial film of the present invention includes: an antibacterial agent including silver; a binder; an antiviral agent; and a fluorine-based surfactant.

### CROSS-REFERENCE TO RELATED APPLICATIONS

This application is a Continuation of PCT International Application No. PCT/JP2019/007554 filed on Feb. 27, 2019, which claims priority under 35 U.S.C. § 119(a) to Japanese Patent Application No. 2018-043461 filed on Mar. 9, 2018. The above application is hereby expressly incorporated by reference, in its entirety, into the present application.

### BACKGROUND OF THE INVENTION

### 1. Field of the Invention

The present invention relates to an antibacterial film, an antibacterial composition, an antibacterial film-attached substrate, and a method for imparting an antibacterial property.

### 2. Description of the Related Art

As a technology for preventing an article such as a touch panel from being contaminated by bacteria and the like, attention has been paid to a technology of providing an antibacterial film on the surface of the article.

WO2015/178166A discloses a device including a hydrophilic processed portion (antibacterial film) including an antibacterial agent including a hydrophilic polymer and silver.

### SUMMARY OF THE INVENTION

These days, there is an increasing demand for an antibacterial film to have not only an antibacterial property but also an antiviral property. Specifically, it is required to impart a function of inactivating a virus (particularly, norovirus) to an antibacterial film.

The inventors of the present invention have found that there is room for further improvement of the antiviral property when an antibacterial film described in WO2015/178166A was prepared and examined for an antiviral property activity against feline calicivirus (a closely related species of norovirus, which is the most widely used surrogate virus at present due to having a genomic composition, a capsid structure, and biochemical properties, which are similar to norovirus) was examined. In addition, the inventors of the present invention have found that the antibacterial film described in WO2015/178166A tends to be discolored (blackening) as the number of times of use increases.

Therefore, an object of the present invention is to provide an antibacterial film excellent in the antibacterial property and the antiviral property and resistant to discoloration.

Another object of the present invention is to provide an antibacterial composition excellent in the antibacterial property and the antiviral property and capable of providing an antibacterial film that is resistant to discoloration.

In addition, another object of the present invention is to provide an antibacterial film-attached substrate provided with the above antibacterial film.

Further, another object of the present invention is to provide a method for imparting an antibacterial property using the above antibacterial film and the above antibacterial composition.

As a result of intensive studies to achieve the above objects, the inventors of the present invention have found that an antibacterial film having a specific composition can solve the above problems, and have completed the present invention.

That is, the objects described above can be achieved by the following configurations.

[1] An antibacterial film comprising: an antibacterial agent including silver; a binder; an antiviral agent; and a fluorine-based surfactant.

[2] The antibacterial film according to [1], in which the antiviral agent includes one or more selected from the group consisting of a hydrophobic antiviral agent having a solubility of 100 g/L or less in water, a metal salt, metallic copper, and a copper compound.

[3] The antibacterial film according to [2], in which the hydrophobic antiviral agent includes one or more selected from the group consisting of a lactic acid oligomer and a metal salt of a lactic acid oligomer.

[4] The antibacterial film according to [2] or [3], in which the metal salt includes a copper salt.

[5] The antibacterial film according to any one of [1] to [4], in which the binder includes a hydrophilic polymer.

[6] The antibacterial film according to any one of [1] to [5], wherein the antibacterial agent including silver includes an inorganic particle supporting silver.

[7] The antibacterial film according to any one of [1] to [6], in which a content of the antibacterial agent including silver is 2.0% to 10% by mass with respect to a total mass of the antibacterial film.

[8] The antibacterial film according to any one of [1] to [7], in which a content of an antiviral agent is 0.1% to 4.0% by mass with respect to a total mass of the antibacterial film.

[9] The antibacterial film according to any one of [1] to [8], in which a content of the fluorine-based surfactant is 0.01% to 1.0% by mass with respect to a total mass of the fluorine-based surfactant.

[10] The antibacterial film according to any one of [1] to [9], in which a content mass ratio of a content of the fluorine-based surfactant to a content of the antiviral agent is 0.03 or more.

[11] The antibacterial film according to any one of [1] to [10], in which a content mass ratio of a content of the antiviral agent to a content of the binder is 0.05 or less.

[12] The antibacterial film according to any one of [1] to [11], in which a content mass ratio of a content of the antiviral agent to a content of the antibacterial agent including silver is 1.0 or less.

[13] An antibacterial composition comprising: an antibacterial agent including silver; a monomer; an antiviral agent; a fluorine-based surfactant; and a solvent.

[14] The antibacterial composition according to [13], in which the antiviral agent includes one or more selected from the group consisting of a hydrophobic antiviral agent having a solubility of 100 g/L or less in water, a metal salt, metallic copper, and a copper compound.

[15] The antibacterial composition according to [14], in which the hydrophobic antiviral agent includes one or more selected from the group consisting of a lactic acid oligomer and a metal salt of a lactic acid oligomer.

[16] The antibacterial composition according to [14] or [15], in which the metal salt includes a copper salt.

[17] The antibacterial composition according to any one of [13] to [16], in which the monomer includes a hydrophilic monomer.

[18] The antibacterial composition according to any one of [13] to [17], in which the antibacterial agent including silver includes an inorganic particle supporting silver.

[19] The antibacterial composition according to any one of [13] to [18], in which a content of the antibacterial agent including silver is 2.0% to 10% by mass with respect to a total solid content.

[20] The antibacterial composition according to any one of [13] to [19], in which a content of the antiviral agent is 0.1% to 4.0% by mass with respect to a total solid content.

[21] The antibacterial composition according to any one of [13] to [20], in which a content of the fluorine-based surfactant is 0.01% to 1.0% by mass with respect to a total solid content.

[22] The antibacterial composition according to any one of [13] to [21], in which a content mass ratio of a content of the fluorine-based surfactant to a content of the antiviral agent is 0.03 or more.

[23] The antibacterial composition according to any one of [13] to [22], in which a content mass ratio of a content of the antiviral agent to a content of the monomer is 0.05 or less.

[24] The antibacterial composition according to any one of [13] to [23], in which a content mass ratio of a content of the antiviral agent to a content of the antibacterial agent including silver is 1.0 or less.

[25] Antibacterial film-attached substrate comprising: a substrate; and the antibacterial film according to any one of [1] to [12] disposed on the substrate.

[26] A method for imparting an antibacterial property, comprising using the antibacterial film according to any one of [1] to [12] or the antibacterial composition according to any one of [13] to [24] to impart an antibacterial property to an object.

According to the present invention, an antibacterial film excellent in the antibacterial property and the antiviral property and resistant to discoloration can be provided.

In addition, according to the present invention, an antibacterial composition excellent in the antibacterial property and the antiviral property and capable of providing an antibacterial film that is resistant to discoloration can be provided.

In addition, according to the present invention, an antibacterial film-attached substrate provided with the above antibacterial film can be provided.

Further, according to the present invention, a method for imparting an antibacterial property using the above antibacterial film and the above antibacterial composition can be provided.

### DESCRIPTION OF THE PREFERRED EMBODIMENTS

In the following description, the invention will be explained in more detail.

The explanation of the constituent elements described below may be based on representative embodiments of the invention; however, the present invention is not intended to be limited to those embodiments.

According to the present specification, a value range described using the symbol “˜” means a range including the numerical values described before and after the symbol “˜” as the lower limit and the upper limit.

In addition, in regard to the description of a group (atomic group) according to the present specification, a description that does not denote substitution or unsubstitution is meant to include a group which does not include a substituent as well as a group which includes a substituent. For example, the description “alkyl group” includes not only an alkyl group that does not include a substituent (unsubstituted alkyl group) but also an alkyl group including a substituent (substituted alkyl group).

In addition, according to the present specification, the description “(meth)acrylate” represents acrylate and methacrylate. According to the present specification, the description “(meth)acryloyl” represents acryloyl and methacryloyl.

[Antibacterial Film]

An antibacterial film of the present invention includes: an antibacterial agent including silver; a binder; an antiviral agent; and a fluorine-based surfactant.

The mechanism by which the above-described antibacterial film provides the effects of the invention is not clearly understood; however, the inventors of the present invention speculate the mechanism as follows. In addition, the invention is not intended to be limited such that the effects are obtainable only by the following mechanism.

The inventors of the present inventions examined the cause of the discoloration of an antibacterial film described in WO2015/178166A and have found that excessive silver ions supplied from an antibacterial agent including silver are blackened by being reduced by the adhesion of a sulfur component in the air, sweat on hands, and sebum. On the other hand, in the antibacterial film of the present invention, since a fluorine-based surfactant is unevenly distributed on the surface of the antibacterial film, only the amount of silver ions necessary for the expression of the antibacterial property is exposed on the surface of the antibacterial film, and the excessive supply of silver ions to the surface of the antibacterial film is suppressed. That is, the antibacterial film of the present invention has both an excellent antibacterial property and an excellent discoloration suppressing property by the silver ions, due to the presence of the fluorine-based surfactant. Particularly, in a case where a binder includes a polymer (hydrophilic polymer) having a hydrophilic group, since silver ions easily move to the surface of the antibacterial film and are repeatedly supplied to the surface of the antibacterial film, the antibacterial property is excellent, but the antibacterial film is usually easily discolored. On the other hand, in the present invention, by the action of the above-described fluorine-based surfactant, even in a case where the antibacterial film includes a hydrophilic polymer, the antibacterial film can maintain an excellent discoloration suppressing property and a stable excellent antibacterial property for a long time.

Furthermore, the inventors of the present invention have found that in a case where the binder includes a hydrophilic polymer and the antiviral agent includes a hydrophobic antiviral agent (for example, a lactic acid oligomer and a metal salt of a lactic acid oligomer), a cissing-like planar defect easily occurs due to the antiviral agent (in other words, the planarity may be inferior). On the other hand, the inventors of the present invention have clarified that the above-mentioned fluorine-based surfactant also contributes to the suppression of the cissing-like planar defect. That is, an antibacterial film including an antibacterial agent including silver, a binder including a hydrophilic polymer, a hydrophobic antiviral agent (for example, a lactic acid oligomer and a metal salt of a lactic acid oligomer), and a fluorine-based surfactant has an excellent antibacterial property and an excellent antiviral property, is not easily discolored, and has excellent planarity.

Hereinafter, various components included in the antibacterial film will be described in detail.

<Antibacterial Agent Including Silver>

The antibacterial film includes an antibacterial agent including silver (hereinafter, also referred to as “silver-based antibacterial agent”).

The silver-based antibacterial agent is not particularly limited, and any known antibacterial agent can be used.

The form of silver in the silver-based antibacterial agent is not particularly limited, and examples include silver metal, silver ion, and a silver salt. According to the present specification, a silver complex is included in the range of silver salt.

The silver salt is not particularly limited, and examples include silver acetate, silver acetylacetonate, silver azide, silver acetylide, silver arsenate, silver benzoate, silver hydrogen fluoride, silver bromate, silver bromide, silver carbonate, silver chloride, silver chlorate, silver chromate, silver citrate, silver cyanate, silver cyanide, silver (cis,cis-1,5-cyclooctadiene)-1,1,1,5,5,5-hexafluoroacetylacetonate, silver diethyldithiocarbamate, silver(I) fluoride, silver(II) fluoride, silver 7,7-dimethyl-1,1,1,2,2,3,3-heptafluoro-4,6-octanedionate, silver hexafluoroantimonate, silver hexafluoroarsenate, silver hexafluorophosphate, silver iodate, silver iodide, silver isothiocyanate, potassium silver cyanide, silver lactate, silver molybdate, silver nitrate, silver nitrite, silver(I) oxide, silver(II) oxide, silver oxalate, silver perchlorate, silver perfluorobutyrate, silver perfluoropropionate, silver permanganate, silver perrhenate, silver phosphate, silver picrate monohydrate, silver propionate, silver selenate, silver selenide, silver selenite, sulfadiazine silver, silver sulfate, silver sulfide, silver sulfite, silver telluride, silver tetrafluoroborate, silver tetraiodomercurate, silver tetratungstate, silver thiocyanate, silver p-toluenesulfonate, silver trifluoromethanesulfonate, silver trifluoroacetate, silver vanadate, a histidine silver complex, a methionine silver complex, a cysteine silver complex, an aspartic acid silver complex, a pyrrolidonecarboxylic acid silver complex, an oxotetrahydrofurancarboxylic acid silver complex, and an imidazole silver complex.

Examples of the silver-based antibacterial agent include organic antibacterial agents such as the above-described silver salts and inorganic antibacterial agents including the carriers that will be described below. However, the type of the silver-based antibacterial agent is not particularly limited.

Among them, in the fact that the antibacterial property of the antibacterial film is more excellent, the silver-based antibacterial agent is preferably a silver-supported carrier including a carrier and silver supported on the carrier.

The type of the carrier is not particularly limited, and examples thereof include zinc-calcium phosphate, calcium phosphate, zirconium phosphate, aluminum phosphate, calcium silicate, activated carbon, activated alumina, silica gel, zeolite, hydroxyapatite, zirconium phosphate, titanium phosphate, potassium titanate, bismuth oxide hydrate, zirconium oxide hydrate, hydrotalcite, and glass (including water-soluble glass).

Among them, in the fact that the antibacterial property of the antibacterial film is more excellent, the carrier is preferably zinc-calcium phosphate, calcium phosphate, zirconium phosphate, aluminum phosphate, zeolite, or glass, and in the fact that the carrier is not deliquescent and the antibacterial film is more stable, the carrier is more preferably zinc calcium phosphate, calcium phosphate, zirconium phosphate, aluminum phosphate, or zeolite.

That is, the silver-based antibacterial agent is preferably an antibacterial agent including a carrier and silver supported on the carrier, in which the carrier is at least one selected from the group consisting of a phosphoric acid salt and a zeolite, in the fact that the antibacterial property of the antibacterial film is more excellent. Examples of the phosphoric acid salt include zinc calcium phosphate, calcium phosphate, zirconium phosphate, and aluminum phosphate.

Examples of the zeolite include natural zeolites such as chabazite, mordenite, erionite, and clinoptilolite and synthetic zeolites such as type A zeolite, type X zeolite, and type Y zeolite.

The average particle size of the silver-based antibacterial agent is not particularly limited; however, generally, the average particle size is preferably 0.1 to 10 μm, and more preferably 0.1 to 2 μm. The aforementioned average particle size is a value obtained by observing a silver-based antibacterial agent using an optical microscope, measuring the diameters of at least random ten particles (primary particles) of the silver-based antibacterial agent, and calculating an arithmetic average of those diameters.

The content of silver in the silver-based antibacterial agent is not particularly limited; however, the content of silver is preferably 0.1% to 10% by mass, and more preferably 0.3% to 5% by mass, with respect to the total mass of the silver-based antibacterial agent.

The content of the silver-based antibacterial agent in the antibacterial film is not particularly limited; however, an amount that provides a silver content of 0.001% to 10% by mass (preferably 0.01% to 5% by mass) with respect to the total mass of the antibacterial film is preferable.

The content of the silver-based antibacterial agent in the antibacterial film is not particularly limited; however, the content of the silver-based antibacterial agent is preferably 0.01% to 20% by mass, more preferably 0.1% to 10% by mass, and still more preferably 2.0% to 10% by mass, with respect to the total mass of the antibacterial film. In a case where an organic antibacterial agent is used as the silver-based antibacterial agent, the content of the antibacterial agent is not particularly limited; however, in the fact that the antibacterial film acquires superior mechanical strength, the content of the organic antibacterial agent is preferably 1.0% to 10% by mass with respect to the total mass of the antibacterial film. In addition, in a case of using an inorganic antibacterial agent as the silver-based antibacterial agent, the content of the antibacterial agent is not particularly limited; however, in the fact that the antibacterial film acquires superior mechanical strength, the content of the inorganic antibacterial agent is preferably 0.01% to 20% by mass, more preferably 0.1% to 10% by mass, and still more preferably 2.0% to 10% by mass, with respect to the total mass of the antibacterial film.

The silver-based antibacterial agent may be used singly, or two or more kinds thereof may be used in combination. In a case where two or more kinds of the silver-based antibacterial agents are used in combination, it is preferable that the total content is in the range described above.

<Binder>

The antibacterial film includes a binder that supports the antibacterial agent and the antiviral agent.

The binder is not particularly limited as long as it is a material capable of supporting the antibacterial agent and the antiviral agent, and examples thereof include a polymer.

The weight-average molecular weight of the above-mentioned polymer is not particularly limited, but is preferably 1,000 to 1,000,000, more preferably 10,000 to 500,000, in the fact that the handling property such as solubility is excellent. In addition, in this specification, a weight-average molecular weight is defined as a polystyrene conversion value obtained by gel permeation chromatography (GPC) measurement.

The kind of the polymer is not particularly limited, but a polymer having a hydrophilic group (hereinafter, also referred to as “hydrophilic polymer”) is preferable due to the fact that it is excellent in antibacterial property and fastness.

For the binder, the polymer may be used alone or two or more kinds thereof may be used in combination, but at least one kind is preferably a hydrophilic polymer.

The hydrophilic group is not particularly limited, and examples include a polyoxyalkylene group (for example, a polyoxyethylene group, a polyoxypropylene group, or a polyoxyalkylene group in which oxyethylene groups and oxypropylene groups are bonded in a block-like fashion or a random fashion), an amino group, a carboxy group, an alkali metal salt of a carboxy group, a hydroxyl group, an alkoxy group, an amide group, a carbamoyl group, a sulfonamide group, a sulfamoyl group, a sulfonic acid group, and an alkali metal salt of a sulfonic acid group. Among them, in the fact that the antibacterial film has superior hard coating performance and/or curling resistance, the hydrophilic group is preferably a polyoxyalkylene group.

The hydrophilic polymer is not particularly limited, and examples thereof include a polymer obtainable by polymerizing a hydrophilic monomer described later, and a polymer obtainable by polymerizing a hydrophilic monomer described later and a non-hydrophilic monomer described later.

The structure of the main chain of the hydrophilic polymer is not particularly limited, and examples include polyurethane, poly(meth)acrylate, polystyrene, polyester, polyamide, polyimide, and polyurea. In a case where the hydrophilic polymer is a polymer obtainable by polymerizing a hydrophilic monomer described later and a non-hydrophilic monomer described later, the mixing ratio (mass of hydrophilic monomer/mass of non-hydrophilic monomer) is preferably 0.01 to 10 and more preferably 0.1 to 10, in the fact that the hydrophilicity of the antibacterial film is controlled easily.

In addition, as the hydrophilic polymer, for example, a cellulose-based compound can also be used. The term “cellulose-based compound” means a compound having cellulose as a mother nucleus, and examples thereof include carboxymethyl cellulose and a nanofiber made of triacetyl cellulose as a raw material.

The content of the binder in the antibacterial film is not particularly limited; however, the content of the binder is preferably 60% by mass or more and more preferably 80% by mass or more, with respect to the total mass of the antibacterial film. In addition, the upper limit value thereof is not particularly limited, but is, for example, 99.9% by mass or less and preferably 98% by mass or less.

<Antiviral Agent>

The antibacterial film includes an antiviral agent.

The antiviral agent is preferably an agent that reduces the activity of viruses belonging to the Caliciviridae, the Orthomyxoviridae, the Coronaviridae, the Herpesviridae, and the like. Examples of viruses belonging to the Caliciviridae include viruses belonging to the genus Norovirus, the genus Sapovirus, the genus Lagovirus, the genus Nebovirus, and the genus Vesivirus. Among the antiviral agents, the antiviral agent is preferably one that exhibits a good inactivating effect on viruses belonging to the genus Norovirus and viruses belonging to the genus Vesivirus.

Specifically, the antiviral agent is preferably one or more selected from the group consisting of a hydrophobic antiviral agent, a metal salt, metallic copper, and a copper compound and more preferably a hydrophobic antiviral agent in the fact that the anti-norovirus property is more excellent. This is because it is difficult to remove the antiviral agent from the film even in a case where the surface of the antibacterial film is wiped off in a case where the antibacterial film includes a hydrophobic antiviral agent

Here, the “hydrophobic antiviral agent” means an antiviral agent having a solubility of 100 g/L or less in water (25° C.). The solubility of the hydrophobic antiviral agent is preferably 10 g/L or less in water (25° C.). The lower limit value of the solubility is not particularly limited but is, for example, 0 g/L.

The hydrophobic antiviral agent does not include a metal salt, metallic copper, a copper compound, each of which will be described later.

Examples of the hydrophobic antiviral agents include a hydrophobic oligomer exhibiting an antiviral property and a metal salt thereof.

The weight-average molecular weight of the hydrophobic oligomer is, for example, 200 to 5,000 and preferably 300 to 4,000.

The hydrophobic antiviral agent is preferably one or more selected from the group consisting of a lactic acid oligomer and a metal salt of a lactic acid oligomer (a metal salt is not particularly limited, but examples thereof include a copper salt, a zinc salt, an iron salt, a silver salt, a platinum salt, a tin salt, and a nickel salt, preferably a copper salt, a zinc salt, or an iron salt and more preferably a copper salt). Among them, a mixture of a lactic acid oligomer and a metal salt of a lactic acid oligomer is more preferable, and a mixture of a lactic acid oligomer and a copper salt of a lactic acid oligomer is still more preferable in the fact that the mixture is more excellent in the anti-norovirus property and more excellent in the fastness. The mixture of the lactic acid oligomer and the metal salt of the lactic acid oligomer can be obtained as a commercial product (for example, IMADEZE manufactured by Koken Co., Ltd.).

In addition, the metal salt that can be used as the antiviral agent is preferably a salt of a metal other than silver, and examples thereof include a copper salt, a zinc salt, and a nickel salt. The metal salt is preferably a copper salt. Examples of the copper salts include copper chloride and copper sulfate. The metal salt described here does not include a hydrophobic antiviral agent in the form of a metal salt and a copper compound described later.

As the metallic copper and the copper compound that can be used as the antiviral agent, a copper particle (for example, a copper nanoparticle), copper oxide, and the like are mentioned. The copper compound described here does not include a copper salt.

In the antibacterial film, the content mass ratio (C/A) of the content (C) of the antiviral agent to the content (A) of the silver-based antibacterial agent is preferably 0.01 or more and more preferably 0.1 or more. Further, the upper limit value thereof is preferably 2.0 or less and more preferably 1.0 or less.

In a case where the content mass ratio (C/A) of the content (C) of the antiviral agent to the content (A) of the silver-based antibacterial agent in the antibacterial film is within the above numerical value range, the obtainable antibacterial film is more excellent in the antibacterial property and the antiviral property since the antibacterial action of the silver-based antibacterial agent having a broad antibacterial spectrum and the antibacterial action of the antiviral agent are synergistic.

In the antibacterial film, the content mass ratio (C/B) of the content (C) of the antiviral agent to the content (B) of the binder is preferably 0.001 or more and more preferably 0.01 or more. Further, the upper limit value thereof is preferably 0.2 or less, more preferably 0.1 or less, and still more preferably 0.05 or less.

As the content of the antiviral agent increases, the antiviral property improves, but the hardness (hard coating performance) of the film tends to decrease. In particular, in a case where a hydrophobic antiviral agent (for example, a mixture of a lactic acid oligomer and a metal salt of a lactic acid oligomer) is used as the antiviral agent, the decrease in the hardness of the film is more remarkable. In the antibacterial film, the content mass ratio (C/B) of the content (C) of the antiviral agent to the content (B) of the binder is in the above numerical value range, the antibacterial film is more excellent in the antiviral property and the hard coating performance.

In the above antibacterial film, in particular, in a case where the binder includes a hydrophilic polymer and the antiviral agent includes a hydrophobic antiviral agent (for example, a mixture of a lactic acid oligomer and a metal salt of a lactic acid oligomer), the cissing-like planar defect due to the hydrophobic antiviral agent is more easily suppressed when the content mass ratio (C/B) of the content (C) of the antiviral agent to the content of the binder (B) is 0.05 or less.

In the antibacterial film, the content mass ratio (D/C) of the content (D) of the fluorine-based surfactant to the content (C) of the antiviral agent is preferably 0.0001 or more and more preferably 0.03 or more. Further, the upper limit value thereof is preferably 1.0 or less and more preferably 0.5 or less.

In a case where in the antibacterial film, the content mass ratio (D/C) of the content (D) of the fluorine-based surfactant to the content (C) of the antiviral agent is 1.0 or less, the antibacterial film has a more uniform film quality since micelles due to the fluorine-based surfactant are not easily formed. That is, the cissing-like planar defect due to the fluorine-based surfactant is further suppressed.

In the above antibacterial film, in particular, in a case where the binder includes a hydrophilic polymer and the antiviral agent includes a hydrophobic antiviral agent (for example, a mixture of a lactic acid oligomer and a metal salt of a lactic acid oligomer), the cissing-like planar defect due to the hydrophobic antiviral agent is more easily suppressed and the planarity is more excellent when the content mass ratio (D/C) of the content of the fluorine-based surfactant (D) to the content of the antiviral agent (C) is 0.0001 or more (preferably 0.03 or more).

The content of the antiviral agent is not particularly limited; however, the content of the antiviral agent is preferably 0.1% to 10% by mass and more preferably 0.1% to 4.0% by mass with respect to the total mass of the antibacterial film in the fact that the planarity of the obtainable antibacterial film is more excellent.

The antiviral agent may be used singly, or two or more kinds thereof may be used in combination. In a case where two or more kinds of the antiviral agents are used in combination, it is preferable that the total content is in the range described above.

<Fluorine-Based Surfactant>

The antibacterial film includes the fluorine-based surfactant.

Examples of the fluorine-based surfactants include: Megafac F-171, F-172, F-173, F-176, F-177, F-141, F-142, F-143, F-144, R-30, F-437, F-475, F-479, F-482, F-554, F-560, F-561, F-780, F-781, MCF-350, and TF1025 manufactured by DIC Corporation; Florard FC430, FC431, and FC171 manufactured by 3M Japan Co., Ltd.; Surflon S-382, SC-101, SC-103, SC-104, SC-105, SC1068, SC-381, SC-383, 5393 and KH-40 manufactured by AGC Inc.; Fluorosurf FS-7024, FS-7025, FS-7026, FS-7027, and FS-7028 manufactured by Fluoro Technology Co., Ltd.; EFTOPEF-101, EF-121, EF-122B, EF-122C, EF-122A3, EF-121, EF-123A, EF-123B, EF-126, EF-127, EF-301, EF-302, EF-351, EF-352, EF-601, EF-801, and EF-802 manufactured by Gemco Co., Ltd.; Futgent 250, 251, 222F, FTX-218, 212M, 245M, 290M, FTX-207S, FTX-211S, FTX-220S, FTS-230S, FTX-209F, FTX-213F, FTX-233F, FTX-245F, FTX-208G, FTX-218G, FTX-230G, FTS-240G, FTX-204D, FTX-208D, FTX-212D, FTX-216D, FTX-218D, FTX-220D, FTX-222D, FTX-720C, and FTX-740C manufactured by Neos Co., Ltd.; and Surflon S-111, S-112, S-113, S-121, S-131, S-132, S-141, S-145, S-381, S-383, S-393, S-101, KH-40, and SA-100 manufactured by AGC Seimi Chemical Co., Ltd.

The content of the fluorine-based surfactant is not particularly limited; however, the content of the fluorine-based surfactant is preferably 0.001% by mass or more, more preferably 0.01% by mass or more, and still more preferably 0.05% by mass or more, with respect to the total mass of the antibacterial film. The upper limit of the content of the fluorine-based surfactant is not particularly limited, but it is preferably 2.0% by mass or less and more preferably 1.0% by mass or less.

The fluorine-based surfactant may be used singly, or two or more kinds thereof may be used in combination. In a case where two or more kinds of the fluorine-based surfactants are used in combination, it is preferable that the total content is in the range described above.

<Other Components>

The antibacterial film may include components other than the above components.

Examples of the other components include a component (for example, a dispersant) included in an antibacterial composition described later, which can be used for forming an antibacterial film, and a component derived from this component.

<Film Thickness>

The film thickness of the antibacterial film is not particularly limited; however, the film thickness is preferably 0.1 to 15 μm, and more preferably 1.0 to 10 μm.

The film thickness is measured by embedding a sample piece of the antibacterial film in a resin, shaving cross sections with a microtome, and observing the shaved cross-sections with a scanning electron microscope. The film thickness is intended to mean a value obtained by measuring the thicknesses at random ten positions of the antibacterial film and calculating an arithmetic average of those values.

[Antibacterial Composition]

An antibacterial composition according to another embodiment of the present invention (hereinafter, also referred to as “composition of the present invention”) includes: an antibacterial agent including silver; a monomer; an antiviral agent; a fluorine-based surfactant; and a solvent.

Hereinafter, the antibacterial composition will be described in detail.

<Antibacterial Agent Including Silver>

The composition includes an antibacterial agent (a silver-based antibacterial agent) including silver. The silver-based antibacterial agent that can be used is as described above.

The content of the silver-based antibacterial agent in the composition is not particularly limited; however, an amount that provides a silver content of 0.001% to 10% by mass (preferably 0.01% to 5% by mass) with respect to the total solid content of the composition is preferable.

In addition, in this specification, the solid content in the composition means all components other than the solvent. In addition, the concentration of the solid contents is a mass percentage of the total mass of other components excluding the solvent with respect to the total mass of the composition.

In addition, the content of the silver-based antibacterial agent in the composition is not particularly limited; however, the content of the silver-based antibacterial agent is preferably 0.01% to 20% by mass, more preferably 0.1% to 10% by mass, and still more preferably 2.0% to 10% by mass, with respect to the total solid content of the composition. In a case where an organic antibacterial agent is used as the silver-based antibacterial agent, the content of the antibacterial agent is not particularly limited; however, in the fact that the obtainable antibacterial film acquires superior mechanical strength, the content of the organic antibacterial agent is preferably 1% to 10% by mass with respect to the total solid content of the composition. In addition, in a case of using an inorganic antibacterial agent as the silver-based antibacterial agent, the content of the antibacterial agent is not particularly limited; however, in the fact that the obtainable antibacterial film acquires superior mechanical strength, the content of the inorganic antibacterial agent is preferably 0.01% to 20% by mass, more preferably 0.1% to 10% by mass, and still more preferably 2.0% to 10% by mass, with respect to the total solid content of the composition.

The silver-based antibacterial agent may be used singly, or two or more kinds thereof may be used in combination. In a case where two or more kinds of the silver-based antibacterial agents are used in combination, it is preferable that the total content is in the range described above.

<Monomer>

The composition includes a monomer as a component for forming a binder.

The monomer may be either a monomer having a hydrophilic group (hereinafter, also referred to as “hydrophilic monomer”) or a monomer having no hydrophilic group (hereinafter, also referred to as “non-hydrophilic monomer”).

The composition preferably includes a hydrophilic monomer and more preferably includes both a hydrophilic monomer and a non-hydrophilic monomer.

Hereinafter, the hydrophilic monomer and the non-hydrophilic monomer will be described.

(Hydrophilic Monomer)

The hydrophilic monomer is a compound having a hydrophilic group and a polymerizable group.

The hydrophilic monomer polymerizes to form a hydrophilic polymer. In a case where the antibacterial film obtainable from the composition includes a hydrophilic polymer, the antibacterial film exhibits stronger hydrophilicity. Thus, In a case where the antibacterial film is washed using water or the like, contaminants adhering onto the antibacterial film can be removed more easily.

The definition of the hydrophilic group is as described above. Among them, in the fact that the antibacterial film obtainable from the above composition acquires superior hard coating performance and/or curling resistance, the hydrophilic group is preferably a polyoxyalkylene group.

The number of hydrophilic groups in the hydrophilic monomer is not particularly limited; however, in the fact that the antibacterial film thus obtainable exhibits stronger hydrophilicity, the number of hydrophilic groups is preferably 2 or larger, more preferably 2 to 6, and even more preferably 2 to 3.

The structure of the main chain of the hydrophilic polymer that is formed of the hydrophilic monomer is not particularly limited, and examples include polyurethane, poly(meth)acrylate, polystyrene, polyester, polyamide, polyimide, and polyurea.

The polymerizable group is not particularly limited, and examples include a radical polymerizable group, a cationic polymerizable group, and an anionic polymerizable group. Examples of the radical polymerizable group include a (meth)acryloyl group, an acrylamide group, a vinyl group, a styryl group, and an allyl group. Examples of the cationic polymerizable group include a vinyl ether group, an oxiranyl group, and an oxetanyl group. Among them, a (meth)acryloyl group is preferable.

The number of polymerizable groups in the hydrophilic monomer is not particularly limited; however, in the fact that the antibacterial film thus obtainable acquires superior mechanical strength, the number of polymerizable groups is preferably 2 or larger, more preferably 2 to 6, and even more preferably 2 to 3.

It is preferable that the composition includes two or more kinds of hydrophilic monomers.

In a case where the composition includes two or more kinds of hydrophilic monomers, the upper limit of kinds of the hydrophilic monomers is not particularly limited, and generally, five or fewer kinds of hydrophilic monomers are preferable.

In a case where the composition includes two or more kinds of hydrophilic monomers, the obtainable antibacterial film acquires a superior antibacterial property.

In addition, in a case where the composition includes two or more kinds of hydrophilic monomers, it is preferable that at least one of the hydrophilic monomers includes at least one polyoxyalkylene group and two or more polymerizable groups in one molecule in the fact that the obtainable antibacterial film is excellent in the hard coating performance and the curling is more reduced.

<<Suitable Aspect of Hydrophilic Monomer>>

One of the suitable aspects of the hydrophilic monomer may be a compound represented by the following Formula (1).

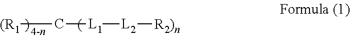

In Formula (1), R₁ represents a substituent. The type of the substituent is not particularly limited, and any known substituent may be used. Examples of the substituents include a hydrocarbon group (for example, an alkyl group or an aryl group) which may have a heteroatom, and the above-mentioned hydrophilic group.

R₂ represents a polymerizable group. The definition of the polymerizable group is as described above.

L₁ represents a single bond or a divalent linking group. The type of the divalent linking group is not particularly limited, and examples thereof include —O—, —CO—, —NH—, —CO—NH—, NH—CO—, —COO—, —OCO—, —O—COO—, —COO—O—, an alkylene group, an arylene group, a heteroarylene group, and combinations thereof.

L₂ represents a polyoxyalkylene group. The polyoxyalkylene group is intended to mean a group represented by the following Formula (2).

*—(OR₃)ₘ—* Formula (2)

In Formula (2), R₃ represents an alkylene group (for example, an ethylene group, a propylene group, and the like). m represents an integer of 2 or greater, preferably 2 to 10, and more preferably 2 to 6. In addition, * represents a bonding position.

n represents an integer of 1 to 4.

Specific examples of the hydrophilic monomer include a polyoxyalkylene-modified pentaerythritol triacrylate and a polyoxyalkylene-modified bisphenol A diacrylate.

The content of the hydrophilic monomer in the composition is not particularly limited; however, the content of the hydrophilic monomer is preferably 0.1% to 50% by mass and more preferably 1% to 25% by mass, with respect to the total solid content of the composition.

The hydrophilic monomers may be used singly, or two or more kinds thereof may be used in combination. In a case where two or more kinds of hydrophilic monomers are used in combination, it is preferable that the total content is in the range described above.

(Non-Hydrophilic Monomer)

The non-hydrophilic monomer is not particularly limited, and any known monomer including a polymerizable group can be used. The definition of the polymerizable group is as described above.

Above all, the monomer is preferably a so-called polyfunctional monomer including two or more polymerizable groups per one molecule in the fact that the obtainable antibacterial film acquires superior mechanical strength. A polyfunctional monomer acts as a crosslinking agent.

The number of polymerizable groups included in the polyfunctional monomer is not particularly limited, and in the fact that the antibacterial film thus obtainable acquires superior mechanical strength, and in the fact that handling of the polyfunctional monomer itself is easy, the number of polymerizable groups is preferably 2 to 10, and more preferably 2 to 6.

Examples of the polyfunctional monomer include trimethylolpropane triacrylate, tetramethylolmethane tetraacrylate, dipentaerythritol hexaacrylate, and pentaerythritol tetraacrylate.

The content mass ratio of the content of the hydrophilic monomer with respect to the content of the non-hydrophilic monomer (mass of hydrophilic monomer/mass of non-hydrophilic monomer) in the composition is not particularly limited; however, in the fact that it is easy to control the hydrophilicity of the obtainable antibacterial film, the mass ratio is preferably 0.01 to 10 and more preferably 0.1 to 10.

As a mixture of a hydrophilic monomer, a non-hydrophilic monomer, and a polymerization initiator, “AICA AITRON Z-949-1L” manufactured by Aica Kogyo Co., Ltd. can be used.

The total amount of the monomer (total amount of hydrophilic monomer and non-hydrophilic monomer) in the composition is not particularly limited; however, in the fact that the obtainable antibacterial film has superior dirt removal characteristics, the total amount is preferably 60% to 99.9% by mass, and more preferably 80% to 98% by mass, with respect to the total solid content of the composition.

<Antiviral Agent>

The composition includes the antiviral agent. The antiviral agent that can be used is as described above.

In the composition, the content mass ratio (C/A) of the content (C) of the antiviral agent to the content (A) of the silver-based antibacterial agent is preferably 0.01 or more and more preferably 0.1 or more. Further, the upper limit value thereof is preferably 2.0 or less and more preferably 1.0 or less.

In a case where the content mass ratio (C/A) of the content (C) of the antiviral agent to the content (A) of the silver-based antibacterial agent in the composition is within the above numerical value range, the obtainable antibacterial film is more excellent in the antibacterial property and the antiviral property since the antibacterial action of the silver-based antibacterial agent having a broad antibacterial spectrum and the antibacterial action of the antiviral agent are synergistic.

In the composition, the content mass ratio (C/B′) of the content (C) of the antiviral agent to the content (B′) of the monomer is preferably 0.001 or more and more preferably 0.01 or more. Further, the upper limit value thereof is preferably 0.2 or less, more preferably 0.1 or less, and still more preferably 0.05 or less. The “content of the monomer” referred to herein means the total amount of the above-described hydrophilic monomer and non-hydrophilic monomer.

In the obtainable antibacterial film, as the content of the antiviral agent increases, the antiviral property improves, but the hardness (hard coating performance) of the film tends to decrease. In particular, in a case where a hydrophobic antiviral agent (for example, a mixture of a lactic acid oligomer and a metal salt of a lactic acid oligomer) is used as the antiviral agent, the decrease in the hardness of the film is more remarkable. In the obtainable antibacterial film, in a case where the content mass ratio (C/B′) of the content (C) of the antiviral agent to the content (B′) of the monomer is in the above numerical value range, the antibacterial film is more excellent in the antiviral property and the hard coating performance.

In the above composition, in particular, in a case where the monomer includes a hydrophilic polymer and the antiviral agent includes a hydrophobic antiviral agent (for example, a mixture of a lactic acid oligomer and a metal salt of a lactic acid oligomer), the cissing-like planar defect due to the hydrophobic antiviral agent is more easily suppressed when the content mass ratio (C/B′) of the content of the antiviral agent (C) to the content of the monomer (B′) is 0.05 or less.

In the composition, the content mass ratio (D/C) of the content (D) of the fluorine-based surfactant to the content (C) of the antiviral agent is preferably 0.0001 or more and more preferably 0.03 or more. Further, the upper limit value thereof is preferably 1.0 or less and more preferably 0.5 or less.

In a case where in the composition, the content mass ratio (D/C) of the content (D) of the fluorine-based surfactant to the content (C) of the antiviral agent is 1.0 or less, the obtainable antibacterial film has a more uniform film quality since micelles due to the fluorine-based surfactant are not easily formed. That is, the cissing-like planar defect due to the fluorine-based surfactant is further suppressed.

In the above composition, in particular, in a case where the monomer includes a hydrophilic monomer and the antiviral agent includes a hydrophobic antiviral agent (for example, a mixture of a lactic acid oligomer and a metal salt of a lactic acid oligomer), the cissing-like planar defect due to the hydrophobic antiviral agent is more easily suppressed and the planarity is more excellent when the content mass ratio (D/C) of the content of the fluorine-based surfactant (D) to the content of the antiviral agent (C) is 0.0001 or more (preferably 0.03 or more).

The content of the antiviral agent is not particularly limited; however, the content of the antiviral agent is preferably 0.1% to 10% by mass and more preferably 0.1% to 4.0% by mass with respect to the total solid content of the composition, in the fact that the planarity of the obtainable antibacterial film is more excellent.

The antiviral agent may be used singly, or two or more kinds thereof may be used in combination. In a case where two or more kinds of the antiviral agents are used in combination, it is preferable that the total content is in the range described above.

<Fluorine-Based Surfactant>

The composition includes the fluorine-based surfactant. The fluorine-based surfactant that can be used is as described above.

The content of the fluorine-based surfactant is not particularly limited; however, the content of the fluorine-based surfactant is preferably 0.001% by mass or more, more preferably 0.01% by mass or more, and still more preferably 0.05% by mass or more, with respect to the total solid content of the composition. The upper limit of the content of the fluorine-based surfactant is not particularly limited, but it is preferably 2.0% by mass or less and more preferably 1.0% by mass or less.

The fluorine-based surfactant may be used singly, or two or more kinds thereof may be used in combination. In a case where two or more kinds of the fluorine-based surfactants are used in combination, it is preferable that the total content is in the range described above.

<Solvent>

The composition includes a solvent.

The solvent is not particularly limited, and water and/or an organic solvent may be used. Examples of the organic solvent include alcohol-based solvents such as methanol, ethanol, n-propanol, isopropanol, n-butanol, isobutanol, sec-butanol, tert-butanol, n-pentanol, and isopentanol; glycol ether-based solvents such as methyl cellosolve, ethyl cellosolve, ethylene glycol dimethyl ether, ethylene glycol diethyl ether, propylene glycol monomethyl ether, propylene glycol monoethyl ether, propylene glycol monopropyl ether, propylene glycol dimethyl ether, and propylene glycol diethyl ether; aromatic hydrocarbon-based solvents such as benzene, toluene, xylene, and ethylbenzene; alicyclic hydrocarbon-based solvents such as cyclopentane, cyclohexane, methylcyclohexane, and ethylcyclohexane; ether-based solvents such as tetrahydrofuran, dioxane, diisopropyl ether, and di-n-butyl ether; ketone-based solvents such as acetone, methyl ethyl ketone, and methyl isobutyl ketone; and ester-based solvents such as methyl acetate, ethyl acetate, n-propyl acetate, isopropyl acetate, n-butyl acetate, isobutyl acetate, n-amyl acetate, isoamyl acetate, hexyl acetate, ethyl propionate, and butyl propionate.

The solvents may be used singly, or two or more kinds thereof may be used in combination.

Among them, in the fact that an antibacterial film having a more uniform film thickness is easily obtained, it is preferable that the composition includes an organic solvent; it is more preferable that the solvent includes an alcohol-based solvent and/or a glycol ether-based solvent, and it is still more preferable that the solvent includes an alcohol-based solvent and a glycol ether solvent.

The concentration of the solid content of the composition is not particularly limited; however, in the fact that the composition has superior coating performance, the solid content is preferably 5% to 80% by mass, and more preferably 20% to 60% by mass.

The solvents may be used singly, or two or more kinds thereof may be used in combination. In a case where two or more kinds of solvents are used in combination, it is preferable that the total content is in the range described above.

<Other Components>

The composition may include other components to the extent that the effects of the invention are provided. Examples of the other components include a polymerization initiator and a dispersant. Hereinafter, an aspect of each component of the other components will be described. The composition may include an antibacterial agent other than the silver-based antibacterial agent.

(Polymerization Initiator)

It is preferable that the composition includes a polymerization initiator. In a case where the composition includes the polymerization initiator, the obtainable antibacterial film has superior mechanical strength.

The polymerization initiator is not particularly limited, and any known polymerization initiator can be used.

Examples of the polymerization initiator include a thermal polymerization initiator and a photopolymerization initiator.

Examples of the polymerization initiator include: aromatic ketones such as benzophenone and phenylphosphine oxide; α-hydroxyalkylphenone-based compounds (manufactured by BASF SE, IRGACURE 184, 127, and 2959, DAROCUR 1173, and the like); and phenylphosphine oxide-based compounds (monoacylphosphine oxide: IRGACURE TPO manufactured by BASF SE and bisacylphosphine oxide: IRGACURE 819 manufactured by BASF SE).

Among them, from the viewpoint of the reaction efficiency, a photopolymerization initiator is preferable.

The content of the polymerization initiator in the composition is not particularly limited; however, the content of the polymerization initiator is preferably 0.1% to 15% by mass and more preferably 1% to 6% by mass, with respect to the total amount of the monomer (the total amount of the hydrophilic monomer and the non-hydrophilic monomer).

The polymerization initiators may be used singly, or two or more kinds thereof may be used in combination. In a case where two or more kinds of polymerization initiators are used in combination, it is preferable that the total content is in the range described above.

(Dispersant)

The composition may include a dispersant.

The dispersant is not particularly limited, and any known dispersant can be used.

Examples of the dispersant include DISPERBYK-180 (a water-soluble, alkylolammonium salt, manufactured by BYK Additives & Instruments).

The content of the dispersant in the composition is not particularly limited; however, generally, the content of the dispersant is preferably 0.01% to 5.0% by mass with respect to the total solid content of the composition.

[Method for Producing Antibacterial Composition]

The composition may be produced by mixing the various components described above. The order of mixing of the above-described components is not particularly limited; however, an aspect of mixing a hydrophilic monomer and a non-hydrophilic monomer in a solvent to obtain a mixture, and mixing this mixture with other components may be also acceptable. At that time, the solvent used for mixing the hydrophilic monomer or the like, and the solvent used for mixing the mixture with other components may be identical or different.

In a case where the composition includes a dispersant, silver-based antibacterial agent particles and the dispersant may be mixed first, and thereby the silver-based antibacterial agent particles may be dispersed in the dispersant.

[Use Applications of Antibacterial Composition]

The composition can be used for the production of an antibacterial film and for the production of an antibacterial film-attached substrate. More specifically, for example, an aspect of producing an ink including the composition, and forming an antibacterial film (antibacterial coating) on the surface of a substrate by an ink jet method or the like.

For the formation of an antibacterial film, a method of irradiating an antibacterial composition layer with UV (ultraviolet) may be used. That is, the composition can also be used as a UV inkjet ink.

In addition, the composition may be used, for example, in an agent form such as a liquid agent, a gel agent, an aerosol spray agent, and a non-aerosol spray agent.

[Antibacterial Film-Attached Substrate]

The antibacterial film-attached substrate according to another embodiment of the present invention includes a substrate and the antibacterial film disposed on the substrate. The antibacterial film-attached substrate may be a laminate having a substrate and an antibacterial film disposed on the substrate and may have an aspect in which the antibacterial film is provided on both surfaces of the substrate.

<Substrate>

The substrate that accomplishes the role of supporting an antibacterial film and the type thereof is not particularly limited. In addition, the substrate may constitute a portion of various apparatuses (for example, a front surface plate).

The shape of the substrate is not particularly limited; however, examples include a plate form, a film form, a sheet form, a tube form, a fiber form, and a particulate form. In addition, the form of the substrate surface on which an antibacterial film is disposed is not particularly limited, and examples include a flat surface, a concave surface, a convex surface, and combinations thereof.

The material that constitutes the substrate is not particularly limited, and examples include a metal, glass, a ceramic, and a plastic (resin). Among them, a plastic is preferable from the viewpoint of handleability. In other words, a resin substrate is preferable.

[Method for Producing Antibacterial Film]

The method for producing an antibacterial film according to another embodiment of the present invention includes the following steps.

<Step A> a step of applying the composition on the surface of a substrate and forming an antibacterial composition layer

<Step B> a step of curing the antibacterial composition layer and obtaining an antibacterial film

(Step A)

Step A is a step of applying the composition on the surface of a substrate and forming an antibacterial composition layer. The method of applying the composition on the surface of a substrate is not particularly limited, and any known coating method can be used.

Examples of the method of applying the composition on the surface of a substrate include a spraying method, a wire bar coating method, an extrusion coating method, a direct gravure coating method, a reverse gravure coating method, an inkjet method, and a die coating method.

The film thickness of the antibacterial composition layer is not particularly limited; however, the film thickness is preferably 0.1 to 15 mm as a dried film thickness.

After the antibacterial composition is applied, the antibacterial composition layer may be subjected to a heating treatment in order to remove the solvent. The conditions for the heating treatment in that case are not particularly limited, and for example, the heating temperature is preferably 50° C. to 200° C., while the heating time is preferably 15 to 600 seconds.

The substrate that can be used in the step A is the same as that of the aspect described above.

(Step B)

Step B is a step of curing the antibacterial composition layer and obtaining an antibacterial film.

The method of curing the antibacterial composition layer is not particularly limited; however, examples include a heating treatment and/or an exposure treatment.

The exposure treatment is not particularly limited; however, for example, an aspect of irradiating the antibacterial composition layer with ultraviolet radiation at a dose of 100 to 600 mJ/cm² using an ultraviolet lamp, and thereby curing the antibacterial composition layer, may be mentioned.

In the case of ultraviolet irradiation, ultraviolet radiation emitted from the light source of an ultrahigh pressure mercury lamp, a high pressure mercury lamp, a low pressure mercury lamp, a carbon arc, a xenon arc, a metal halide lamp, or the like can be utilized.

The temperature for the heating treatment is not particularly limited; however, for example, the temperature is preferably 50° C. to 150° C., and more preferably 80° C. to 120° C.

[Method for Producing Antibacterial Film-Attached Substrate]

The method for producing an antibacterial film-attached substrate according to another embodiment of the present invention is a method for producing an antibacterial film-attached substrate, the method comprising a step of forming an antibacterial film on the surface of a substrate.

The step of forming an antibacterial film is not particularly limited; however, the following several aspects are preferable. The substrate is as described above.

<Suitable Aspect 1>

A step of applying the composition on the surface of a substrate, forming an antibacterial composition layer, curing the antibacterial composition layer, and thus obtaining an antibacterial film.

The suitable aspect 1 is similar to the aspect previously explained as the method for producing an antibacterial film.

<Suitable Aspect 2>

A step of laminating the substrate and the antibacterial film.

Regarding the suitable aspect 2, a method of applying an adhesive onto a substrate and/or an antibacterial film, forming an adhesive layer, laminating the substrate and the antibacterial film, and then curing the adhesive as necessary, may be mentioned.

The adhesive is not particularly limited, and any known adhesive can be used.

Examples of the types for the adhesive include a hot melt type, a thermosetting type, a photocuring type, a reaction curing type, and a pressure-sensitive adhesive type that does not require curing. As the materials thereof, acrylate-based, urethane-based, urethane acrylate-based, epoxy-based, epoxy acrylate-based, polyolefin-based, modified olefin-based, polypropylene-based, ethylene vinyl alcohol-based, vinyl chloride-based, chloroprene rubber-based, cyanoacrylate-based, polyamide-based, polyimide-based, polystyrene-based, and polyvinyl butyral-based compounds can be used.

[Method for Imparting Antibacterial Property]

The method for imparting an antibacterial property of the embodiment of the present invention is not particularly limited, but in a case where the antibacterial composition of the embodiment of the present invention is used, the antibacterial composition can be applied or can be applied in advance onto places where bacteria and viruses such as Escherichia coli, influenza virus, and norovirus adhere or may adhere. The method for applying the composition is not particularly limited, and examples thereof include a method for spraying the composition on the above-mentioned places and a method for wiping the above-mentioned places with a foundation cloth including the composition. In addition, in a case where the antibacterial film of the present invention is used, a method of applying the antibacterial film on the substrate (article to which antibacterial property is desired to be imparted) by the above-described method for producing antibacterial film-attached substrate is mentioned.

### EXAMPLES

Hereinafter, the invention will be described in more detail based on Examples. The materials, amounts of use, proportions, treatments, procedures, and the like described in the following Examples can be modified as appropriate as long as the gist of the invention is maintained. Therefore, the scope of the present invention should not be construed to be limited by Examples described below.

[Preparation of Antibacterial Composition and Production of Antibacterial Film-Attached Substrate]

An antibacterial composition was prepared by mixing various components and a solvent, and an antibacterial film having a formulation ratio (solid content ratio) shown in Table 1 was produced by the procedure described below.

<Preparation of Antibacterial Composition>

The antibacterial composition was prepared by mixing a silver-based antibacterial agent, a hydrophilic monomer, a non-hydrophilic monomer, a polymerization initiator, an antiviral agent, a fluorine-based surfactant, a dispersant, and a solvent (isopropyl alcohol (IPA) was used as a solvent), each of which will be described later, so that the concentration of solid content was 35.0% by mass.

<Production of Antibacterial Film-Attached Substrate>

Antibacterial film-attached substrates were obtained by the following method using the antibacterial compositions.

The antibacterial compositions were applied on the surface of a polyethylene terephthalate (PET) sheet (COSMOSHINE A4300 manufactured by Toyobo Co., Ltd.) so as to obtain antibacterial films having the film thicknesses of 5.0 μm and dried for 2 minutes at 120° C. Subsequently, the monomers and the like were cured by irradiating the antibacterial compositions with UV (ultraviolet), and thus, antibacterial film-attached substrates were formed.

<Various Components>

The various components shown in Table 1 are indicated below.
BACTERITE MP102SVC13 (manufactured by Fuji Chemical Industries Co., Ltd.; CaZn-based Ag phosphate; having a silver content of 1% by mass and corresponding to a silver-based antibacterial agent; corresponding to an inorganic particles supporting silver)
NOVALON AG300 (manufactured by Toagosei Co., Ltd.; Zr-based Ag phosphate; having a silver content of 3% by mass; corresponding to a silver-based antibacterial agent; corresponding to an inorganic particles supporting silver.)
AICA AITRON Z-949-1L (manufactured by Aica Kogyo Co., Ltd.; including a hydrophilic monomer, a non-hydrophilic monomer, and a polymerization initiator)
IMADEZE (corresponding to a mixture of a lactic acid oligomer and a copper salt of a lactic acid oligomer, manufactured by Koken Ltd.) Both the lactic acid oligomer and the metal salt of the lactic acid oligomer correspond to hydrophobic antiviral agents, and the solubility thereof in water (25° C.) is 100 g/L or less.)
Megafac F-780 (manufactured by DIC Corporation; corresponding to a fluorine-based surfactant)
Fluorosurf FS-7027 (manufactured by Fluoro Technology Co., Ltd.; corresponding to a fluorine-based surfactant)
DISPERBYK 180 (manufactured by BYK Additives & Instruments; corresponding to a dispersant)
TOKUSO IPA (isopropyl alcohol) SE (trade name) (manufactured by Tokuyama Corporation; corresponding to an alcohol-based solvent)

[Various Evaluations]

(Antibacterial Property)

A test was carried out according to JIS-Z-2801: 2010, using Escherichia coli as a test bacterium and by changing the time of contacting with the bacterial solution to 3 hours. The antibacterial activity value after the test was measured, and evaluation was performed according to the following criteria. For practical use, “B” or more is preferable.

(Evaluation Criteria)

“A”: The antibacterial activity value was 3.0 or more.

“B”: The antibacterial activity value was 2.0 or more and less than 3.0.

“C”: The antibacterial activity value was less than 2.0.

Antibacterial activity value: the relationship between the number of live bacteriall cells U_{b} after 3 hours in unprocessed test pieces and the number of live bacteriall cells T_{b} after 3 hours in each level of test pieces, which is expressed as below.

Antibacterial activity value=log₁₀(U_{b}/T_{b})

(Antiviral Property)

The test was performed with reference to JIS-Z-2801 and ISO18184 standards. A virus solution prepared to have a concentration of about 10⁸ PFU/mL in a Minimum Essential Media (MEM) culture medium was diluted 10 times with sterilized distilled water to obtain a test virus solution. Feline calicivirus, which is a substitute for norovirus, was used as the virus. Each sample was inoculated with 0.4 mL of the test virus solution, and a polyethylene film of 16 cm² was covered thereon to closely attach the sample, and the sample was left at 25° C. for 24 hours. Then, 10 mL of washout solution was added, and the virus was washed out from the sample by pipetting. As the washout solution, a Soybean-Casein Digest Broth with Lecithin and Polysorbate 80 (SCDLP) culture medium supplemented with a serum to a final concentration of 10% was used. The virus infectivity titer in the washout solution was measured, the antiviral activity value was calculated from the infectivity titer per 1 cm² of the coated film, and the evaluation was performed according to the following criteria. For practical use, “B” or more is preferable.

(Evaluation Criteria)

“A”: The antiviral activity value was 3.0 or more.

“B”: The antiviral activity value was 2.0 or more and less than 3.0.

“C”: The antiviral activity value was less than 2.0.

Antiviral activity value: the relationship between the virus infectivity titer Uᵥ after 24 hours in unprocessed test pieces and the virus infectivity titer Tᵥ after 24 hours in each level of test pieces, which is expressed as below.

Antiviral activity value=log₁₀(Uᵥ/Tᵥ)

(Discoloration Suppressing Property)

A test film cut into a 10 cm square with double-sided tape was laminated to a veneer plate cut into a 10 cm square, having a thickness of 2.5 mm, and laminated with a white plastic film so that the surface coated with the antibacterial layer was the outermost layer and then pressed with the finger to attach the finger mark. The test film on which the finger mark was attached was allowed to be left in a living room illuminated by light for 20 days, and the degree of discoloration of the portion on which the finger mark was attached was evaluated according to the following criteria. For practical use, “B” or more is preferable.

(Evaluation Criteria)

“A”: No discoloration was confirmed.

“B”: Very slight discoloration was confirmed.

“C”: A slight discoloration was confirmed.

“D”: Discoloration was clearly confirmed.

(Planarity (Suppressing Property of Cissing-Like Planar Defect))

The test film was cut into A4 size, and the cissing-like planar defects present in the plane were visually counted, and the cissing-like planar defects were evaluated according to the following criteria. For practical use, “B” or more is preferable.

(Evaluation Criteria)

“A”: The number of defects was 0.

“B”: The number of defects was 1.

“C”: The number of defects was 2 or 3.

“D”: The number of defects was 4 or more.

Table 1 shows the antibacterial films of Examples and Comparative Examples.

In Table 1, the content of each component is expressed in percentage (%) by mass with respect to the total mass of the antibacterial film. In Table 1, “AICA AITRON Z-949-1L (manufactured by Aica Kogyo Co., Ltd.)” described in the binder (B) column is a mixture of a hydrophilic monomer and a non-hydrophilic monomer as described above, which has a form of a polymer (hydrophilic polymer) having a hydrophilic group in the antibacterial film after the polymerization.

In addition, although Table 1 shows the formulation of the various components as the antibacterial film composition, the solid content ratio of the various components in the composition is roughly the same as the formulation ratio of Table 1 for the antibacterial composition for forming the antibacterial film.

In addition, in Table 1, “Content mass ratio C/A” means the “content of antiviral agent/content of silver-based antibacterial agent”.

In addition, in Table 1, “Content mass ratio C/B means the “content of antiviral agent/content of binder”.

In addition, in Table 1, “Content mass ratio D/C” means the “content of fluorine-based surfactant/content of antiviral agent”.

TABLE 1

| | Composition of antibacterial film | | | | | | | | |
|---|---|---|---|---|---|---|---|---|---|
| | Silver-based | | | | | | Fluorine-based | | |
| | antibacterial agent | | Binder | | Antiviral agent | | surfactant | | |
| | (A) | | (B) | | (C) | | (D) | | |
| | | Content | | Content | | Content | | Content | |
| | | (% by | | (% by | | (% by | | (% by | Dispersant |
| | Kind | mass) | Kind | mass) | Kind | mass) | Kind | mass) | Kind |
| Example 1 | BACTERITE | 6.5 | AICA | 91 | IMADEZE | 2.0 | Megafac | 0.01 | DISPERBYK |
| | MP102SVC13 | | AITRON | | | | F-780 | | 180 |
| | | | Z-949-1L | | | | | | |
| Example 2 | BACTERITE | 6.5 | AICA | 91 | IMADEZE | 2.0 | Megafac | 0.1 | DISPERBYK |
| | MP102SVC13 | | AITRON | | | | F-780 | | 180 |
| | | | Z-949-1L | | | | | | |
| Example 3 | BACTERITE | 6.5 | AICA | 91 | IMADEZE | 2.0 | Megafac | 0.1 | DISPERBYK |
| | MP102SVC13 | | AITRON | | | | F-780 | | 180 |
| | | | Z-949-1L | | | | | | |
| Example 4 | BACTERITE | 6.5 | AICA | 91 | IMADEZE | 2.0 | Megafac | 0.1 | DISPERBYK |
| | MP102SVC13 | | AITRON | | | | F-780 | | 180 |
| | | | Z-949-1L | | | | | | |
| Example 5 | BACTERITE | 6.5 | AICA | 88 | IMADEZE | 5.0 | Megafac | 0.1 | DISPERBYK |
| | MP102SVC13 | | AITRON | | | | F-780 | | 180 |
| | | | Z-949-1L | | | | | | |
| Example 6 | BACTERITE | 4.0 | AICA | 94 | IMADEZE | 2.0 | Megafac | 0.1 | DISPERBYK |
| | MP102SVC13 | | AITRON | | | | F-780 | | 180 |
| | | | Z-949-1L | | | | | | |
| Example 7 | BACTERITE | 1.5 | AICA | 97 | IMADEZE | 2.0 | Megafac | 0.1 | DISPERBYK |
| | MP102SVC13 | | AITRON | | | | F-780 | | 180 |
| | | | Z-949-1L | | | | | | |
| Example 8 | NOVALON | 6.5 | AICA | 91 | IMADEZE | 2.0 | Megafac | 0.1 | DISPERBYK |
| | AG300 | | AITRON | | | | F-780 | | 180 |
| | | | Z-949-1L | | | | | | |
| Comparative | BACTERITE | 6.5 | AICA | 91 | IMADEZE | 2.0 | — | — | DISPERBYK |
| Example 1 | MP102SVC13 | | AITRON | | | | | | 180 |
| | | | Z-949-1L | | | | | | |
| Comparative | BACTERITE | 6.5 | AICA | 88 | IMADEZE | 5.0 | — | — | DISPERBYK |
| Example 2 | MP102SVC13 | | AITRON | | | | | | 180 |
| | | | Z-949-1L | | | | | | |
| Comparative | BACTERITE | 6.5 | AICA | 83 | IMADEZE | 10 | — | — | DISPERBYK |
| Example 3 | MP102SVC13 | | AITRON | | | | | | 180 |
| | | | Z-949-1L | | | | | | |
| Comparative | BACTERITE | 6.5 | AICA | 93 | — | — | — | — | DISPERBYK |
| Example 4 | MP102SVC13 | | AITRON | | | | | | 180 |
| | | | Z-949-1L | | | | | | |
| | | | | | | Evaluation | | | |
| | | | | | | Antibacterial | | | |
| | | Composition of antibacterial film | | | | property | Antibacterial | | |
| | | Dispersant | | | | (value of | property | | |
| | | Content | Content | Content | Content | antibacterial | (anti-norovial | Discoloration | |
| | | (% by | ratio | ratio | ratio | property against | property | suppressing | |
| | | mass) | C/A | C/B | D/C | Escherichia coli | (24 h)) | property | Planarity |
| | Example 1 | 0.5 | 0.31 | 0.02 | 0.005 | A | A | B | B |
| | Example 2 | 0.5 | 0.31 | 0.02 | 0.05 | A | A | A | A |
| | Example 3 | 0.5 | 0.31 | 0.02 | 0.05 | A | A | A | A |
| | Example 4 | 0.5 | 0.31 | 0.02 | 0.05 | A | A | A | A |
| | Example 5 | 0.5 | 0.77 | 0.06 | 0.02 | A | A | A | B |
| | Example 6 | 0.3 | 0.50 | 0.02 | 0.05 | A | A | A | A |
| | Example 7 | 0.1 | 1.3 | 0.02 | 0.05 | B | A | A | A |
| | Example 8 | 0.5 | 0.31 | 0.02 | 0.05 | A | A | A | A |
| | Comparative | 0.5 | 0.31 | 0.02 | — | A | A | D | B |
| | Example 1 | | | | | | | | |
| | Comparative | 0.5 | 0.77 | 0.06 | — | A | A | D | C |
| | Example 2 | | | | | | | | |
| | Comparative | 0.5 | 1.5 | 0.12 | — | A | A | D | D |
| | Example 3 | | | | | | | | |
| | Comparative | 0.5 | — | — | — | A | C | D | A |
| | Example 4 | | | | | | | | |

From the results in Table 1, it is clear that the antibacterial films of Examples are excellent in the antibacterial property, the antiviral property, and the discoloration suppressing property.

In addition, from the comparison of Examples 1 to 3 and Examples 5 to 7, it has been confirmed that in a case where the content of the fluorine-based surfactant in the antibacterial film is 0.05% to 1.0% by mass with respect to the total mass of the antibacterial film, the antibacterial film is more excellent in the discoloration suppressing property and the planarity.

In addition, from the comparison of Examples 1 to 3 and Examples 5 to 7, it has been confirmed that in a case where the content mass ratio (D/C) of the content of the fluorine-based surfactant (% by mass of D) to the content of the antiviral agent (% by mass of C) in the antibacterial film is 0.03 or more, the antibacterial film is more excellent in the planarity.

In addition, from the comparison of Examples 1 to 3 and Examples 5 to 7, it has been confirmed that in a case where the content of the antiviral agent in the antibacterial film is 0.1% to 4.0% by mass with respect to the total mass of the antibacterial film, the antibacterial film is more excellent in the planarity.

In addition, from the comparison of Examples 1 to 3 and Examples 5 to 7, it has been confirmed that in a case where the content mass ratio (C/B) of the content of the binder to the content of the antiviral agent in the antibacterial film is 0.05 or less, the antibacterial film is more excellent in the planarity.

In addition, from the comparison of Examples 1 to 3 and Examples 5 to 7, it has been confirmed that in a case where the content of the silver-based antibacterial agent in the antibacterial film is 2.0% to 10% by mass with respect to the total mass of the antibacterial film, the antibacterial film is excellent both in the antibacterial property and the antiviral property.

In addition, from the comparison of Examples 1 to 3 and Examples 5 to 7, it has been confirmed that in a case where the content mass ratio (C/A) of the content of the antiviral agent to the content of the silver-based antibacterial agent is 1.0 or less, the obtainable antibacterial film is excellent both in the antibacterial property and the antiviral property.

On the other hand, it has been confirmed that the antibacterial films of Comparative Examples (Comparative Examples 1 to 4) including no fluorine-based surfactant were inferior in the discoloration suppressing property. Further, among the above Comparative Examples, in a case where the binder includes a hydrophilic polymer and the antiviral agent includes a hydrophobic antiviral agent (Comparative Examples 1 to 3), the cissing-like planar defect due to the antiviral agent occurs.

What is claimed is:

1. An antibacterial film comprising:
an antibacterial agent including silver;
a binder;
an antiviral agent; and
a fluorine-based surfactant.

2. The antibacterial film according to claim 1, wherein the antiviral agent includes one or more selected from the group consisting of a hydrophobic antiviral agent having a solubility of 100 g/L or less in water, a metal salt, metallic copper, and a copper compound.

3. The antibacterial film according to claim 2, wherein the hydrophobic antiviral agent includes one or more selected from the group consisting of a lactic acid oligomer and a metal salt of a lactic acid oligomer.

4. The antibacterial film according to claim 2, wherein the metal salt includes a copper salt.

5. The antibacterial film according to claim 1, wherein the binder includes a hydrophilic polymer.

6. The antibacterial film according to claim 1, wherein the antibacterial agent including silver includes an inorganic particle supporting silver.

7. The antibacterial film according to claim 1, wherein a content of the antibacterial agent including silver is 2.0% to 10% by mass with respect to a total mass of the antibacterial film.

8. The antibacterial film according to claim 1, wherein a content of an antiviral agent is 0.1% to 4.0% by mass with respect to a total mass of the antibacterial film.

9. The antibacterial film according to claim 1, wherein a content of the fluorine-based surfactant is 0.01% to 1.0% by mass with respect to a total mass of the antibacterial film.

10. The antibacterial film according to claim 1, wherein a content mass ratio of a content of the fluorine-based surfactant to a content of the antiviral agent is 0.03 or more.

11. The antibacterial film according to claim 1, wherein a content mass ratio of a content of the antiviral agent to a content of the binder is 0.05 or less.

12. The antibacterial film according to claim 1, wherein a content mass ratio of a content of the antiviral agent to a content of the antibacterial agent including silver is 1.0 or less.

13. An antibacterial composition comprising:
an antibacterial agent including silver;
a monomer;
an antiviral agent;
a fluorine-based surfactant; and
a solvent.

14. The antibacterial composition according to claim 13, wherein the antiviral agent includes one or more selected from the group consisting of a hydrophobic antiviral agent having a solubility of 100 g/L or less in water, a metal salt, metallic copper, and a copper compound.

15. The antibacterial composition according to claim 14, wherein the hydrophobic antiviral agent includes one or more selected from the group consisting of a lactic acid oligomer and a metal salt of a lactic acid oligomer.

16. The antibacterial composition according to claim 14, wherein the metal salt includes a copper salt.

17. The antibacterial composition according to claim 13, wherein the monomer includes a hydrophilic monomer.

18. The antibacterial composition according to claim 13, wherein the antibacterial agent including silver includes an inorganic particle supporting silver.

19. The antibacterial composition according to claim 13, wherein a content of the antibacterial agent including silver is 2.0% to 10% by mass with respect to a total solid content.

20. The antibacterial composition according to claim 13, wherein a content of the antiviral agent is 0.1% to 4.0% by mass with respect to a total solid content.

21. The antibacterial composition according to claim 13, wherein a content of the fluorine-based surfactant is 0.01% to 1.0% by mass with respect to a total solid content.

22. The antibacterial composition according to claim 13, wherein a content mass ratio of a content of the fluorine-based surfactant to a content of the antiviral agent is 0.03 or more.

23. The antibacterial composition according to claim 13, wherein a content mass ratio of a content of the antiviral agent to a content of the monomer is 0.05 or less.

24. The antibacterial composition according to claim 13, wherein a content mass ratio of a content of the antiviral agent to a content of the antibacterial agent including silver is 1.0 or less.

25. An antibacterial film-attached substrate comprising:
a substrate; and
the antibacterial film according to claim 1 disposed on the substrate.

26. A method for imparting an antibacterial property, comprising:
using the antibacterial film according to claim 1 to impart an antibacterial property to an object.

27. A method for imparting an antibacterial property, comprising:
using the antibacterial composition according to claim 13 to impart an antibacterial property to an object.
